(19) United States
(12) Patent Application Publication
(10) Pub. No.: US 2026/0355912 A1
(43) Pub. Date: Nov. 12, 2026

(54) SIDE ENTRY SOCKET FOR A SOCKET WRENCH

(71) Applicant: Raymond MURPHY, Antigonish (CA)

(72) Inventor: Raymond MURPHY, Antigonish (CA)

(21) Appl. No.: 19/203,984

(22) Filed: May 9, 2025

(51) Int. Cl. B25B 13/48; B25B 13/46; B25B 23/00

(52) U.S. Cl. CPC B25B 13/481; B25B 23/0035; B25B 13/461

(57) ABSTRACT

A socket for a socket wrench is described. The socket includes a body defining a longitudinal axis; a fastener end at one side of the body, and a drive end at another side of the body. The drive end includes a drive recess sized and shaped to receive a protrusion from a drive tool. The drive recess is formed of a plurality of side walls configured to engage the protrusion. A lateral opening is formed in one of the side walls of the drive recess and extends to the edge of the drive end. The lateral opening is sized and shaped to allow the protrusion to be inserted into the drive recess from a direction transverse to the longitudinal axis of the body. A socket wrench including the socket and a drive tool is also described.

The present disclosure relates generally to sockets for socket wrenches, and specifically to a socket having a side entrance for receiving a driving tool of the socket wrench.

### BACKGROUND

Socket wrenches are widely used tools for applying rotational force to fasteners such as nuts and bolts. These tools provide an efficient means of tightening or loosening fasteners while reducing the need for repositioning, making them a preferred choice in mechanical, automotive, and industrial applications. A socket wrench comprises a driving tool and one or more interchangeable sockets. Socket wrenches may be known by other names, such as socket spanners and ratchet and socket sets, for example.

The driving tool, often referred to as a ratchet, is designed with an internal gear and pawl mechanism that allows for unidirectional motion. This mechanism permits the user to apply torque to the fastener in one direction while allowing free motion in the opposite direction without requiring the tool to be lifted or repositioned. A directional switch on the ratchet enables users to alternate between tightening and loosening operations.

The sockets are interchangeable attachments that fit a corresponding fastener and connect to the ratchet handle via a drive square. The drive square, also referred to as a drive square, is a four-sided projection protruding from the ratchet. The drive square serves as the primary interface between the ratchet and socket, ensuring a secure and torque-transmitting connection.

While socket wrenches provide significant mechanical advantage, their effectiveness can be limited in tight or confined spaces. For example, the ratchet requires a certain degree of movement to engage the gear mechanism effectively. In restricted areas, the user may not have enough space to move the handle back and forth, limiting its functionality. As another example, in recessed or obstructed locations, accessing the fastener with a straight socket attachment may be difficult. The limited room may prevent proper alignment between the socket and the fastener head. As another example, in some applications such as automotive or machinery applications, surrounding parts may restrict the ability to maneuver the ratchet or change socket sizes conveniently.

To overcome these difficulties, various extensions, universal joints, and low-profile ratchets have been developed to enhance accessibility and usability in tight spaces. However, despite these advancements, there remains a need for improvements in socket wrench design to further optimize performance in constrained environments.

### SUMMARY

In accordance with an aspect of an embodiment, there is provided a socket for a socket wrench, the socket including: a body defining a longitudinal axis; a fastener end at one side of the body, a drive end at another side of the body. The drive end includes a drive recess sized and shaped to receive a protrusion from a drive tool. The drive recess is formed of a plurality of side walls configured to engage the protrusion. A lateral opening is formed in one of the side walls of the drive recess and extends to the edge of the drive end. The lateral opening is sized and shaped to allow the protrusion to be inserted into the drive recess from a direction transverse to the longitudinal axis of the body.

The fastener end may include a fastener recess sized and shaped to engage a fastener. The fastener end and the drive end may be on opposing sides of the socket.

The lateral opening may be sized and shaped to match the size and shape of the protrusion. The lateral opening may be greater at an outer perimeter of the side wall than at an inner parameter of the side wall, thereby creating a lead-in ramp to the drive recess. At least one of the side walls may comprise a notch shaped to receive a detent ball positioned on the protrusion.

The depth of the drive recess may be greater than a distance d that the lateral opening extends from the edge of the drive recess, thereby creating a bottom portion of the drive recess that is surrounded by side walls on all sides. The bottom portion of the drive recess may be at least ⅛″ deep.

The drive recess may be substantially rectangular cuboid in shape. The drive recess may be substantially cubic in shape.

In accordance with another aspect of an embodiment, there is provided a socket wrench including a drive tool comprising a protrusion and the socket as described above.

### BRIEF DESCRIPTION OF THE DRAWINGS

Embodiments will now be described by way of example only with reference to the following drawings in which:

FIG. 1 is a socket wrench;

FIG. 2 is a bottom view of a socket;

FIG. 3a is an upper perspective view of the socket;

FIG. 3b is a top view of the socket; and

FIG. 3c is a top view of an alternative embodiment of the socket.

### DETAILED DESCRIPTION

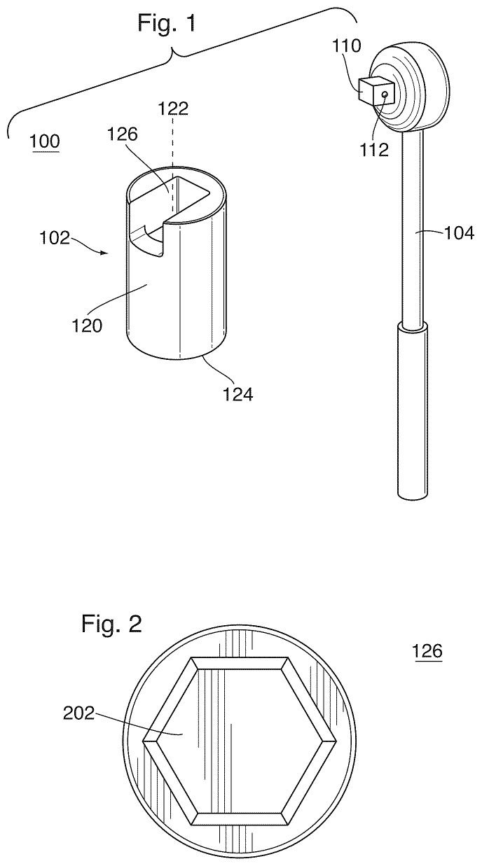

For convenience, like numerals in the description refer to like structures in the drawings. Referring to FIG. 1, a socket wrench is illustrated generally by numeral 100. The socket wrench 100 includes a socket 102 and a drive tool, or ratchet, 104. The ratchet 104 includes a protrusion 110, extending therefrom. In some embodiments, the protrusion 110 includes one or more detent balls 112.

In some embodiments, the protrusion 110 is a drive square. The drive square 110 is a cubic-shaped metal protrusion on the ratchet 104 configured to engage the socket 102. The drive square 110 can come in a number of sizes including, for example, ¼ inch, ⅜ inch, ½ inch, ⅝ inch, ¾ inch, 1 inch, 1½ inch, 2½ inch and 3½ inch. Common sizes include, for example, a ¼ inch drive for small fasteners and precision work, a ⅜ inch drive for general use, a ½ inch drive for heavy-duty applications, and a ¾ inch or larger drive for industrial or automotive work. Other sizes may be used, including metric bases sizes.

In some embodiments, the detent ball 112 is positioned on a side of the drive square 110. The detent ball 112 is spring loaded and, as will be described, is used to strengthen the engagement between the ratchet 104 and the socket 102. In some embodiments two detent balls 112 are positioned on the sides of the drive square 110. Each detent ball 112 may be positioned on adjacent sides or on opposite sides. In some embodiments three detent balls 112 are positioned on the sides of the drive square 110. Each detent ball 112 may be positioned on adjacent sides. In some embodiments four detent balls 112 are positioned on the sides of the drive square 110. Each detent ball 112 may be positioned on a corresponding side.

The socket 102 includes a body 120 defining a longitudinal axis 122. The socket 102 further includes a fastener end 124 at one side of the body 120 and a drive end 126 at another side of the body 120. In some embodiments, the fastener end 124 and the drive end 126 are on opposing sides of the socket 102.

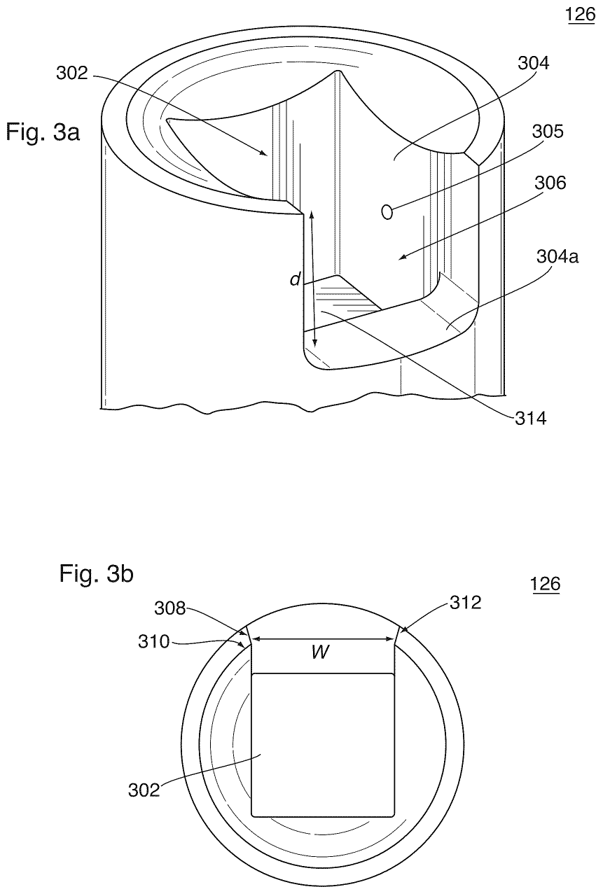

Referring to FIG. 2, the fastener end 124 of the socket 102 is illustrated. In some embodiments, the fastener end 124 includes a fastener recess 202 sized and shaped to receive a male end of a fastener. In the illustrated embodiment, the fastener recess 202 is hexagonal. However, different sockets 102 will have different sized and shaped fastener recesses 202 to engage fasteners having different shapes and sizes. In some embodiments, the fastener end 124 of the socket 102 includes a fastener protrusion (not shown) sized and shaped to engage a female fastener.

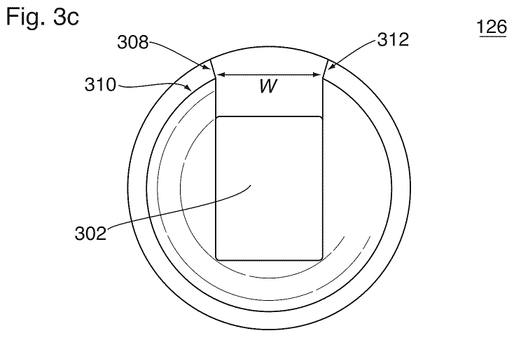

Referring to FIGS. 3a and 3b, the drive end 126 is illustrated. The drive end 126 includes a drive recess 302 sized and shaped to receive the drive square 110 from the ratchet 104. The drive recess 302 is formed of a plurality of side walls 304. The side walls 304 are configured to engage the drive square 110. That is, in some embodiments, the drive square 110 fits snugly into the drive recess 302. In some embodiments, one or more of the internal surfaces includes a notch 305 positioned to receive the detent ball 112 of the drive square 110.

In some embodiments, one of the side walls 304a comprises a lateral opening 306. The opening 306 extends to the edge of the drive end 126. In some embodiments, the width w of the opening 306 is sized to snugly receive the drive square 110. In some embodiments, the width of the opening 306 is wider at the external perimeter 308 of the side wall 304a than at the inner perimeter 310 of the side wall. The difference in width creates a lead-in ramp 312 to the drive recess 302.

The opening 306 extends a predefined distance d from the edge of the drive recess 302. In some embodiments, the distance d is the same as the length of the drive square 110. In some embodiments, the distance d is less than the length of the drive square 110. In some embodiments, the distance d is greater than the length of the drive square 110.

In some embodiments, the depth of the drive recess 302 is greater than the distance d that the opening extends from the edge of the drive recess 302. This configuration creates a bottom portion 314 of the drive recess 302 that is surrounded by side walls on all sides. In some embodiments, the bottom portion 314 of the drive recess 302 is at least ⅛″ deep.

In conventional socket wrenches, the drive square 110 of the ratchet 104 is inserted axially into the drive recess 302. This configuration requires vertical clearance for tool engagement and operation. However, in certain applications, such as when working near obstructions, walls, or confined engine compartments, vertical access to the drive recess 302 may be limited or entirely obstructed. As described above, the socket 102 has a lateral opening 306 formed in its side wall. The opening 306 is dimensioned to receive the drive square 110 of the ratchet 104. Thus, the drive square 110 of the ratchet 104 can be inserted into the drive recess 302 from a direction substantially transverse to the longitudinal axis of the socket 102. This side-access configuration enables torque to be applied to the fastener even when vertical access is restricted.

Further, as the drive square 110 of the ratchet 104 is inserted into the drive recess 302, the lead-in ramp 312 compresses the detent balls 112. When the drive square 110 is inserted to a target position, the detents balls 112 engage with the notches 305 in the side wall 304 of the drive recess 302. This engagement helps keep the ratchet 104 in place.

As described above, the drive recess 302 is cubic in shape to facilitate compatibility with existing protrusions 110, which are typically drive squares. However, the shape of the drive recess 302 can be modified to facilitate other shapes.

For example, the protrusion 110 can be a rectangular cuboid shape that is not cubic. That is, not all the sides of the protrusion 110 may be equal. Thus, as illustrated in FIG. 3c, the drive recess 302 is sized and shaped to receive the rectangular protrusion. In some embodiments, the opening 306 is sized and shaped to receive a narrower end of the protrusion 110. In some embodiments, the opening 306 is sized and shaped to receive a wider end of the protrusion 110.

The scope of the claims should not be limited by the embodiments set forth in the above examples, but should be given the broadest interpretation consistent with the description as a whole. The terms “a”, “an” and “one” are defined to mean “at least one”, that is, these terms do not exclude a plural number of items, unless stated otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof.

Terms such as “substantially”, “generally” and “about”, which modify a value, condition or characteristic of a feature of an example embodiment, should be understood to mean that the value, condition or characteristic is defined within tolerances that are acceptable for the proper operation of this embodiment for its intended application.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.).

Spatially relative terms, such as “inner,” “outer,” “beneath,” “below,” “lower,” “above,” “upper,” “top”, “bottom,” and the like, may be used herein for ease of description to describe one element's or feature's relationship to another element(s) or feature(s) as illustrated in the figures. For convenience, the relative terms used in the application relate to a user holding a crossbow facing forward as a reference frame. However, spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly. “At least one” means one or more, and “a plurality of” means two or more. The term “and/or” describes an association relationship of associated objects, and indicates that three relationships may exist. For example, A and/or B may indicate the following three cases: Only A exists, both A and B exist, and only B exists, where A and B may be singular or plural. The character “/” usually indicates an “or” relationship between associated objects. “At least one of the following items (pieces)” or a similar expression thereof indicates any combination of these items, including a single item (piece) or any combination of a plurality of items (pieces). For example, “at least one of A, B, or C” includes A, B, C, A and B, A and C, B and C, or A, B, and C, and “at least one of A, B, and C” may also be understood as including A, B, C, A and B, A and C, B and C, or A, B, and C. In addition, unless otherwise specified, ordinal numbers such as “first” and “second” in embodiments of this application are used to distinguish between a plurality of objects, and are not used to limit a sequence, a time sequence, priorities, or importance of the plurality of objects.

The description in the present application should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function.

Benefits, other advantages, and solutions to problems have been described above with regard to specific embodiments. However, the benefits, advantages, solutions to problems, and any feature(s) that can cause any benefit, advantage, or solution to occur or become more pronounced are not to be construed as a critical, required, sacrosanct or an essential feature of any or all the claims.

After reading the specification, skilled artisans will appreciate that certain features which are, for clarity, described herein in the context of separate embodiments, can also be provided in combination in a single embodiment. Conversely, various features that are, for brevity, described in the context of a single embodiment, can also be provided separately or in any sub-combination. Further, references to values stated in ranges include each and every value within that range.

It is clearly that a person skilled in the art can make various modifications and variations to this application without departing from the scope of this application. This application is intended to cover these modifications and variations of this application provided that they fall within the scope of protection defined by the following claims and their equivalent technologies.

What is claimed is:

1. A socket for a socket wrench, the socket comprising:
a body defining a longitudinal axis;
a fastener end at one side of the body,
a drive end at another side of the body, the drive end comprising a drive recess sized and shaped to receive a protrusion from a drive tool, the drive recess formed of a plurality of side walls configured to engage the protrusion; and
a lateral opening formed in one of the side walls of the drive recess and extending to the edge of the drive end, the lateral opening being sized and shaped to allow the protrusion to be inserted into the drive recess from a direction transverse to the longitudinal axis of the body.

2. The socket of claim 1, wherein the fastener end comprises a fastener recess sized and shaped to engage a fastener.

3. The socket of claim 1, wherein the fastener end and the drive end are on opposing sides of the socket.

4. The socket of claim 1, wherein the lateral opening is sized and shaped to match the size and shape of the protrusion.

5. The socket of claim 1, wherein at least one of the side walls comprises a notch shaped to receive a detent ball positioned on the protrusion.

6. The socket of claim 1, wherein the lateral opening is greater at an outer perimeter of the side wall than at an inner parameter of the side wall, thereby creating a lead-in ramp to the drive recess.

7. The socket of claim 1, wherein the depth of the drive recess is greater than a distance d that the lateral opening extends from the edge of the drive recess, thereby creating a bottom portion of the drive recess that is surrounded by side walls on all sides.

8. The socket of claim 7, where the bottom portion of the drive recess is at least ⅛″ deep.

9. The socket of claim 1, wherein the drive recess is substantially rectangular cuboid in shape.

10. The socket of claim 9, wherein the drive recess is substantially cubic in shape.

11. A socket wrench comprising:
a drive tool comprising a protrusion; and
a socket comprising:
a body defining a longitudinal axis;
a fastener end at one side of the body,
a drive end at another side of the body, the drive end comprising a drive recess sized and shaped to receive the protrusion from the drive tool, the drive recess formed of a plurality of side walls configured to engage the protrusion; and
a lateral opening formed in one of the side walls of the drive recess and extending to the edge of the drive end, the lateral opening being sized and shaped to allow the protrusion to be inserted into the drive recess from a direction transverse to the longitudinal axis of the body.

12. The socket wrench of claim 11, wherein the fastener end comprises a fastener recess sized and shaped to engage a fastener.

13. The socket wrench of claim 11, wherein the fastener end and the drive end are on opposing sides of the socket.

14. The socket wrench of claim 11, wherein the lateral opening is sized and shaped to match the size and shape of the protrusion.

15. The socket wrench of claim 11, wherein the protrusion of the drive tool comprises at least one detent ball and at least one of the side walls comprises a notch shaped to receive the detent ball.

16. The socket wrench of claim 11, wherein the lateral opening is greater at an outer perimeter of the side wall than at an inner parameter of the side wall, thereby creating a lead-in ramp to the drive recess.

17. The socket wrench of claim 11, wherein the depth of the drive recess is greater than a distance d that the lateral opening extends from the edge of the drive recess, thereby creating a bottom portion of the drive recess that is surrounded by side walls on all sides.

18. The socket wrench of claim 17, where the bottom portion of the drive recess is at least ⅛″ deep.

19. The socket wrench of claim 18, wherein the protrusion and the drive recess are substantially rectangular cuboid in shape.

20. The socket wrench of claim 19, wherein the protrusion and the drive recess are substantially cubic in shape.
